(19) United States
(12) Patent Application Publication
(10) Pub. No.: US 2004/0133436 A1
(43) Pub. Date: Jul. 8, 2004

(54) Safety management method and system for using biological agent

(76) Inventor: Keith Alan Swain, Wilmington, DE (US)

Correspondence Address: E I du Pont de Nemours & Company, Legal Patents, Wilmington, DE, 19898, US

(21) Appl. No.: 10/476,917

(22) PCT Filed: May 2, 2002
(86) PCT No.: PCT/US02/13980

(51) Int. Cl. G06F 17/60

(52) U.S. Cl. 705/1

(57) ABSTRACT

A computer-implemented method and computing system for the collaborative evaluation and management of the potential safety hazards attendant upon the use of one or more biological agents is disclosed.

### BACKGROUND OF THE INVENTION

1. Field of the Invention

This invention relates to a computer-implemented method and computing system for the collaborative evaluation and control of the potential safety hazards attendant upon the use of one or more biological agents.

2. Description of the Prior Art

Management of safety issues, such as hazard evaluation, is often an ad hoc informal process. The process relies upon the knowledge of a safety professional regarding generalized safety procedure coupled with the knowledge of the experienced researcher regarding specific hazards associated with the material being employed. However, knowledge of generalized and highly technical safety procedures may not insure that all relevant regulations and standards are made available when dealing with potential biological hazards. Accordingly, the risks inherent to such an informal process are exacerbated when dealing with biological materials.

In view of the foregoing it is believed particularly advantageous, especially for an entity for which safety is a core value, to provide a computer-implemented evaluation process which provides a more formalized review of the hazards associated with the intended use of a biological agent, and which is standardized and repeatable for each use of a biological agent. It is believed that further advantage is achieved by using a decision engine that, based upon the nature of the biological agent(s) involved for the intended use, determines the hazard level and identifies all relevant regulations and standards to be practiced.

### SUMMARY OF THE INVENTION

The present invention is directed toward a computer-implemented method and computing system for the collaborative evaluation and control of the potential safety hazards attendant upon the use of one or more biological agents.

In accordance with the method of the present invention a user-experimenter prepares and submits to an audit agency a listing of parameters regarding a proposed use of a biological agent. The listing includes the identity of a biological agent proposed to be used by a user, the use to which the biological agent is proposed to be put, the medium in which the biological agent proposed use will occur, and the containment system in which the proposed use will be practiced. Based upon the received parameters a decision engine is used by the user and/or the audit agency to determine a hazardous risk classification of the biological agent. The user receives from the audit agency a bio-safety level designation of the use, the bio-safety level designation being based upon the hazardous risk classification.

The user submits for review by the audit agency a proposed set of operating procedures and conditions governing the proposed use. The degree of specificity of the information in the list is dependent upon the bio-safety level designation. Thereafter, the audit agency returns to the user comments regarding the informational items submitted. The comments may optionally include modifications to the proposed set of operating procedures and conditions. The submission and return is repeated as necessary until an approval by the audit agency is received. The approval contains a final set of operating procedures and conditions.

Thereafter, the user-experimenter practices the use in accordance with final set of operating procedures and conditions.

The system of the present invention comprises a server node and at least one user node. The server node has a memory partitioned into two user-accessible sections: a document processing section and an archive or repository section. The document processing section has at least one document contained within it. Documents may be contained within an electronic folder, called a workbook. The workbook contains documents that have been created by a user acting as an author and documents signed by the author that have been electronically forwarded for review by an audit agency.

The archive or repository section contains approved workbooks with the associated author-signed and approver-signed documents. Each workbook in the archive is affiliated with one or more users and contains documents that have been created and signed by that user acting as an author and that have been reviewed and approved and signed by the audit agency.

Each user node is operable in either an author mode, a review/approval mode, or read-only mode. When operable in the author mode the user node is connectable to the document within a workbook within the user's work space for storage of an unsigned document and retrieval of a previously-stored unsigned document for editing and/or signing by that user acting as an author. The author-signed document includes a signature string representative of the identity of that user acting as an author, a first date/time stamp provided by the server, and a document edit history. When the user acting as an author has signed a document, the document may be stored in a workbook of that user in the document processing section of the system memory and is forwarded to one or more reviewers (i.e., the audit agency) designated by the author.

When the user node is operable in the review/approval mode the user node is connectable to the system memory for retrieval of a signed document or workbook for review and comment or approval-signing by a user (a member of the audit agency) acting as an approver. Documents that have received comments are forwarded to the author for further revision. Documents that have been approved include the approver signature and a date/time stamp provided by the server node and a document review/edit history string. After the approver has approved the author-signed signed document the user node is connectable to the document processing section for storage of the signed and approved document in a workbook therein. The approver-signed documents may then be forwarded to the archive section.

Although the system administrator may grant read-only access to other users, access by other users to in-progress documents within a workbook, contained in the document processing section, is controlled by the author. The author may designate another user as an “additional author” for a document or for an entire workbook. The author may designate a “reviewer/approver” by selecting from a list of authorized users having “reviewer/approver” authority.

When a workbook has been designated by the author as “complete” and has been approved by the audit agency, that workbook is transferred to the archive section of the memory. The system administrator has access control for workbooks in the archive section of the memory.

### BRIEF DESCRIPTION OF THE DRAWINGS

The invention will be more fully understood from the following detailed description, taken in connection with the accompanying drawings which form a part of this application in which:

FIG. 1 is a high-level block diagram of an safety management process for managing the use of a biological agent in accordance with the present invention;

FIG. 2 is a flow diagram showing the hazard evaluation decision engine used in the process of claim 1;

FIG. 3 is a stylized diagrammatic representation of a computing system for practicing the process of FIG. 1; and

FIG. 4 is a flow diagram showing the archive document management process.

### DETAILED DESCRIPTION OF THE INVENTION

Throughout the following detailed description, similar reference numerals refer to similar elements in all of the figures of the drawings.

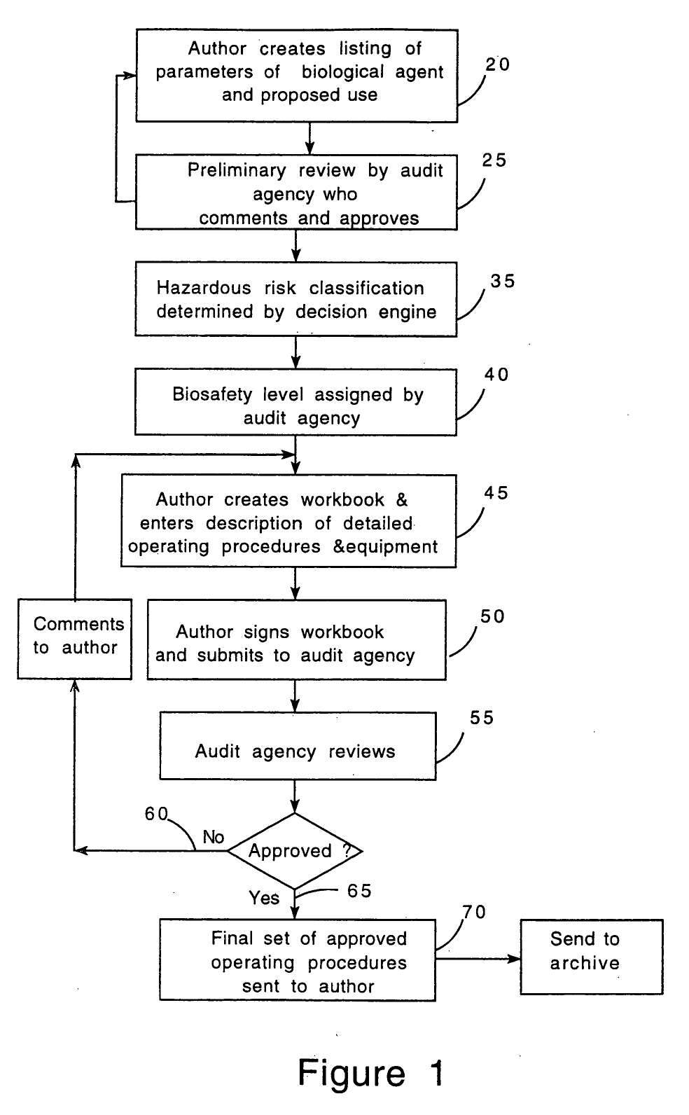

FIG. 1 is a high level block diagram of an safety management process, generally indicated by reference numeral 10, for managing the use of a biological agent in accordance with the present invention. The safety management process 10 is believed to provided a more formalized and standardized procedure than the ad hoc process available in the art for assessing the safety risks attendant upon the use of a biological agent. The process 10 here described presupposes the existence or the creation of a safety management audit agency that includes one or more safety professionals. The audit agency may take any of a variety of forms, such as a formally trained biological safety officer or a committee formed of safety professional(s), knowledgeable researcher(s) and management representative(s) who have been delegated authority over safety procedures. If the committee form is used, actions attributable to the agency may be practiced by the full agency or a sub-group thereof.

The first step in the formalized process is the creation by the user of a listing of parameters regarding the proposed use of a biological agent. This action is indicated by reference numeral 20. The listing includes the nature and identity of the biological agent proposed to be used by the user, the use to which the biological agent is proposed to be put, the medium in which the proposed use will occur, and the containment system in which the proposed use will be practiced. The listing may further include: a recommended bio-safety level designation for the proposed use, the type of user(s) (e.g., researcher, technician or operator); the level of training of the user(s) (e.g., formal academic training or specific training in safety procedure); regulations to be followed for the biological agent; and the level of medical assessment and observation required for the user of the biological agent.

The user forwards the parameter listing to the audit agency for a preliminary review as indicated by block 25. The primary purpose for this preliminary review is to ascertain that the parameter listing conforms to the appropriate regulations and standards.

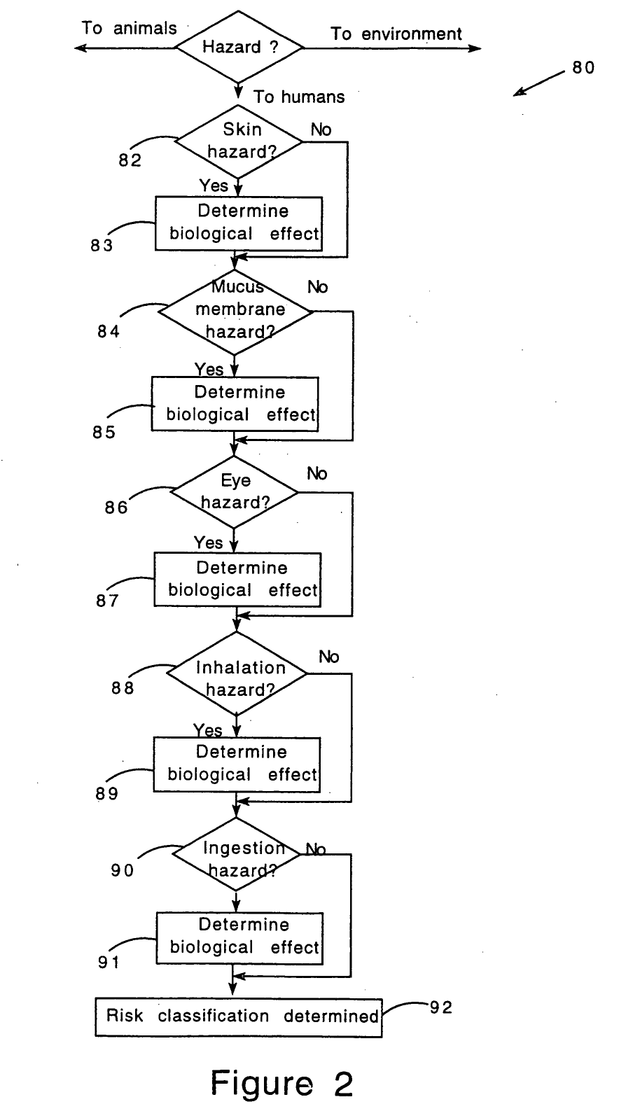

Upon approval of the parameter listing by the audit agency a decision engine is used to implement a decision analysis that determines a hazardous risk classification of the biological agent. This action is indicated at block 35. The decision analysis is discussed in connection with FIG. 2.

Based upon the hazardous risk classification determined by the decision engine, a bio-safety level designation for the proposed use is assigned by the audit agency and returned to the proposed user. This action is indicated in the block 40. The bio-safety level designation is a measure of the containment required for work with the particular biological agent under consideration. The bio-safety level designation returned to the proposed user is indicated by reference numeral 40.

As a next step, as indicated by reference numeral 45, the proposed user creates a document containing a description of the detailed operating procedures and conditions governing the proposed use. This description may also include description of the equipment to be used to carry out the proposed use. This document is contained within an electronic folder termed a “workbook”. The document in the workbook is more detailed than the listing of the parameters created in connection with step 20. The degree of specificity of the information in the document is dependent upon the bio-safety level designation.

The workbook is submitted by the proposed user to the audit agency for review and approval, as indicated by reference numeral 50. The workbook is reviewed by the audit agency for the appropriateness and adequacy of the proposed operating procedures and conditions in view of the hazardous risk classification and bio-safety level designation.

The audit agency decides whether or not to approve the items in the workbook, as indicated at decision block 55. If the audit agency withholds its approval comments are returned to the proposed user, as indicated by reference numeral 60. The comments may optionally include proposed modifications to the set of proposed operating procedures and conditions.

Steps 50, 55 and 60 are iterated as needed until an approval containing a final set of operating procedures and conditions is granted by the audit agency.

Upon approval by the audit agency the final set of approved operating procedures and conditions is provided to the proposed user, as indicated by the block designated by reference numeral 65. The approved operating procedures and conditions are also archived in a repository.

The user practices the use in accordance with the final set of operating procedures and conditions, as indicated by the block 70.

The process of the present invention can accommodate changes. A proposed change in biological agent serves to revoke automatically the approval by the audit agency. Prior to any change in the biological agent the entire process (that is, the steps in the blocks 20 through 70) must be repeated. If the biological agent remains the same, prior to implementing any newly-proposed change in operating procedures and conditions, the steps in blocks 45 through 70 must be repeated.

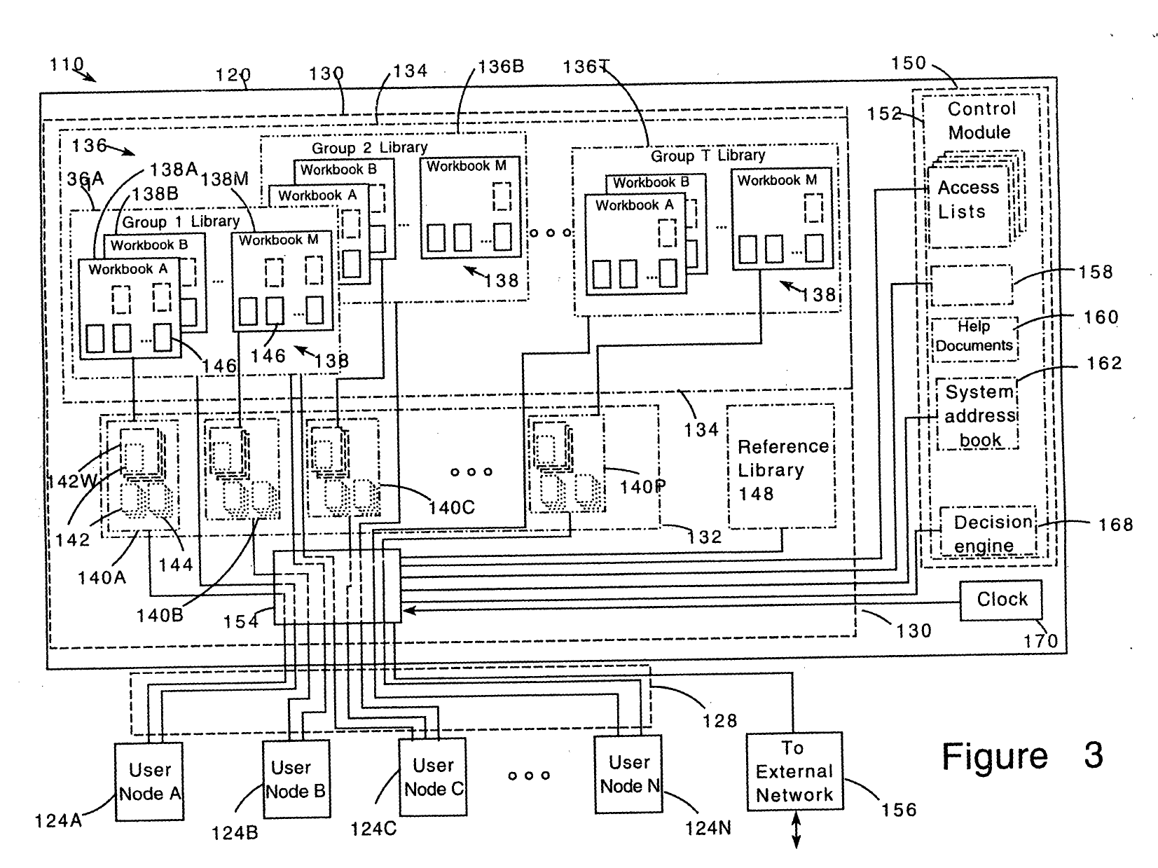

The decision analysis used to determine a hazardous risk classification is shown in FIG. 2. The parameters concerning the biological agent (previously reviewed by the audit agency) are examined to determine the hazard level, as shown by the decision block 80. The decision engine that implements the decision analysis uses criteria contained within a reference library 148 (FIG. 3) to determine if the biological agent is a hazard to the environment, to animals, or to humans.

If a human hazard (i.e., a risk of a biological effect to a human) is identified then an identification of the mode of entry of the agent into the human organism is made. Whether the biological agent will produce a biological effect upon skin contact (including percutaneous entry), upon contact with a mucus membrane, upon contact with the eye membrane, through inhalation or through ingestion, is determined, as respectively indicated by reference numeral 82, 84, 86, 88 and 90. The identification of the mode of entry may be made in any sequence.

In addition, for each mode of entry identified, the severity of the biological effect of the agent on a human is identified. The identifications of severity for each mode of entry is indicated in respective associated blocks 83, 85, 87, 89 and 91.

Based upon the mode of entry and the severity of the effect a hazardous risk classification is assigned to the biological agent, as indicated by reference numeral 92. Decision criteria within the reference library 148 is derived from information which has been extracted from recognized safety references and standards, in addition to locally generated safety methods and hazard knowledge. The decision criteria is typically collected in tabular form and is referenced by the decision engine software module 168 (FIG. 3).

FIG. 3 shows a stylized diagrammatic representation of the architecture of a safety management computing system 110 in accordance with of the present invention. The system 110 comprises a server node 120 and, at least one, but more preferably, a plurality of user nodes 124A through 124N. As will be described in more detail herein each user node 124 is operable in either an “author mode” by a user, in a “review/approval mode” by an audit agency, or in a “read-only” mode by another user. It should be understood that the term “user node” denotes a hardware location at which an individual user may interact with the system 110. The number N of user nodes is not necessarily the same as the number of individual users of the system.

The server node 120 comprises one or more processors, random access memory, and one or more storage devices. A preferred arrangement for the server node comprises a Compaq “Proliant 6500” with four Pentium Pro processors running under Microsoft's NT 4.0 Service Pack 6a operating system and Lotus Development Corporation server software sold as Notes Domino Server 4.5.7. The server comprises four two-hundred megahertz (200 MHz) processors, one gigabyte of random access memory (RAM), and seven internal 18.2 gigabyte disk drives in a RAID5 configuration.

The user nodes 124 are typically implemented using a personal computer, such as a PC-compatible running Microsoft Windows® 95 operating system or later, or an Apple MacIntosh® computer running MAC OS 7 operating system or later. The user nodes run Lotus Notes® Version 4.5 or later user node module, sold Lotus Development Corporation.

The user nodes are connected to the server node 120 using a standard networking configuration 128, such as an Ethernet® network connection, having Transfer Control Protocol (TCP) with internet protocol (IP), a combination known as TCP/IP.

The server node 120 includes a memory 130 that is partitioned to define a user-accessible document processing section 132 and a delete-protected repository, or document archive, section 134. The memory 130 can be implemented using any suitable storage medium, typically a combination of random access semiconductor memory and a magnetic or optical memory.

Project work being generated by each user is recorded in “in-progress” documents 142 stored in a user workspace 140 of the document processing section 132. In-progress documents 142 may be stored within a workbook 142W in the user workspace 140. A user acting as an author has the authority to grant access to his/her in-progress documents 142. Documents 144 that have been signed by the author and submitted for review but not yet reviewed by the audit agency continue to reside in the user workspace 140 of the document processing section 132.

The repository section 134 is partitioned to define at least one, but more preferably, a plurality of group libraries 136A through 136T. Each group library 136 is dedicated to a single collaborative group of one or more individual users. Each group library 136 contains approved review workbook(s) 138A through 138N. Each workbook 138 may contain one or more approved documents 146 (i.e., documents that have been reviewed and approved by the audit agency). One or more of the workbook(s) 138 in each group library 136 is(are) assigned to and affiliated with each user forming part of the group. It should be understood that the number of documents 146 in each workbook 138 stored in each group library 136 may be different.

As determined by the system administrator, all user nodes 124 typically have at least read-only access to all documents and workbooks within the group libraries 136.

A reference and resources library 148 provides users access to copies of selected standards and regulations that are stored in the system 110. The library 148 also contains intranet and/or internet links whereby the user may be connected to resources external to the system 110 containing other regulations and standards. Information in the library 148 may be incorporated by an author into in-progress documents 142. Alternatively, intranet and internet links in the library may be incorporated into in-progress documents 142 or author-signed documents 144 and audit agency-approved documents 146 for informational purposes. The library 148 may also provide the mode of entry (FIG. 2, blocks 82, 84, 86, 88, 90) and the severity criteria (FIG. 2, blocks 83, 85, 87, 89, 91) for the decision analysis of biological agents being evaluated.

A control program 150 that effects the overall operation of system 110 resides in the memory 130. The control program 150 may be implemented in any suitable software application and operating system environment. One software application suitable to implement the control program 150 is that program sold by Lotus Development Corporation as Notes® Domino Server Version 4.5.7 or later.

The control program 150 includes a control module 152 that serves to organize the described arrangement of memory 130, to implement an interface 154 between the server node 120 and the user nodes 124, to implement an interface 156 between user nodes 124 and an external network, and to perform other functions in connection with the operation of the system 110.

The control program 150 also includes a database administration module 158 to permit access to users to the system 110 in defined roles: author, reviewer/approver, or reader (i.e., read-access only). The administration module 158 also manages the information presented in the database “Help” documents 160 and a system address book 162.

The control module 152 also includes a software module 168 to implement the decision engine for the hazardous risk classification. The decision engine uses criteria contained within the reference and resources library 148, as has been more fully described in conjunction with FIG. 2.

The control program 150 also implements a document library search module 151, which provides users a key-word search capability of documents within the user-accessible section 132 and the repository section 134. Documents 142, 144, 146 (or portions thereof) can be accessed and copied into in-progress documents 142.

The server node 120 also includes a clock 170 from which date/time stamps may be derived. The clock 170 may be accessed by a system administrator, but is inaccessible to a user.

The use of the system 110 in implementing the process of the present invention may now be discussed. The listing of parameters regarding the proposed use of a biological agent (FIG. 1, block 20) is created by a user acting as an author in the user workspace 140 as a preliminary listing of parameters document 142. When the document is complete the author signs the document. An author signature string and a date/time stamp is entered into the document 142 by the server 120 to create a author-signed listing of parameters document 144. The author sends the listing of parameters document 144 to the audit agency, typically using an electronic mail message with an attached document link.

A single member of the audit agency, the so-called bio-safety officer, may review and comment on or approve the listing of parameters document 144 (FIG. 1, block 25). Alternatively that single member may forward the document to other members of the audit agency using an electronic mail message with an attached document link. When comments are made by other members of the audit agency, they are forwarded to the bio-safety officer, who collects the comments and forwards them to the author (FIG. 1, arrow 30).

When the document 144 is approved at least one approval signature string and server-generated date/time stamp is appended to the document 144 to create an approved document 146 and an electronic mail message with an attached document link is returned to the author. A copy of the approved document 146 may be archived in the repository 134.

The approved list of parameters is used by the decision engine software module 158 to determine a hazardous risk classification (FIG. 1, block 35), as more fully described in conjunction with FIG. 2. The hazardous risk classification is returned to the author (FIG. 1, block 40).

Using the approved listing of parameters document 146 and the hazardous risk classification as a starting point, the author creates and edits one or more hazard review documents 142 (FIG. 1, block 45) and provides informational items concerning the proposed procedures and conditions. The informational items are prompted by providing the author with a list of informational requirements. The specificity of informational requirements is selected in accordance with the bio-safety level designation. The informational items may include a description of the equipment to be used to carry out a proposed procedure, a description of the steps of the procedure to be performed and specific conditions to be maintained.

A collection of predetermined document formats stored in the reference library 148 is provided to assist the author: a Standard Operating Procedure (SOP) format, an Equipment Safety Audit (ESA) and related Potential Physical Hazards (PPH) documents, a Mini-Hazard Review (MHR) document (for lower-risk hazards), a Research Safety Review (RSR) (for moderate-risk hazards), and a Process Hazards Review (PSR) (for higher-risk hazards). The author selects the appropriate format or formats and records applicable information about the proposed procedure in the selected formats within the hazard review document.

The author may forward completed and signed hazard review documents 144 either individually or as a group to the audit agency. After completing editing of one or more documents 142 the author signs the document(s) (FIG. 1, block 50). The system appends a date/time stamp and sends the now-signed document(s) 144 as an electronic mail with the document link to the audit agency for their review and approval.

The members of the audit agency review the document(s) for appropriate content and either comment or indicate approval (FIG. 1, block 55). Reviewers append comments to an electronic mail message linked to the document(s) and return it to the author for further revision (FIG. 1, block 60) or approve the document(s) with their signature/date/time stamp (FIG. 1, block 65). The system sends an electronic mail with the document link to the author informing the author of the comments of the audit agency or the approval of the document(s).

The author may create additional documents as required for hazard management documentation. These documents may be based upon the formats stored in the reference library 148, as discussed above.

Field Survey When the author has received individually approved documents 146, the author collates these documents into a “review workbook”, to prepare the collated review workbook for a complete review by the audit agency. The act of collating the documents into a review workbook permits further editing of the documents. The author signs and sends the collated review workbook 144 to the audit agency for review. This is again carried out by electronic mail with a document link. The reviewers can send comments about the document content to the author via electronic mail with a document link.

After audit agency review of the collated review workbook, the author and selected members of the audit agency conduct a field survey of the equipment, facilities and approved procedures that had been recorded in the review workbook. Based upon this field survey, the author may further edit one or more documents to incorporate the findings of the field survey and prepare that document for further review by the audit agency.

Final Review When the author has received the results of the further review by the audit agency, the author collates the reviewed document(s) into the review workbook, to prepare the collated review workbook for a complete review by the audit agency. The author signs and sends the collated review workbook 144 to the audit agency for final review and approval. This is again carried out by electronic mail with a document link. The reviewers send their approval of the review workbook content to the author via electronic mail with a document link.

The approved review workbook 146 is archived as an archived workbook 138 within the designated library 136 within the repository 134. A history of the biological agent parameters, hazardous risk classification, audit agency comments and approvals, operating procedures and conditions and audit agency comments and approvals thereof is also maintained in the system archive.

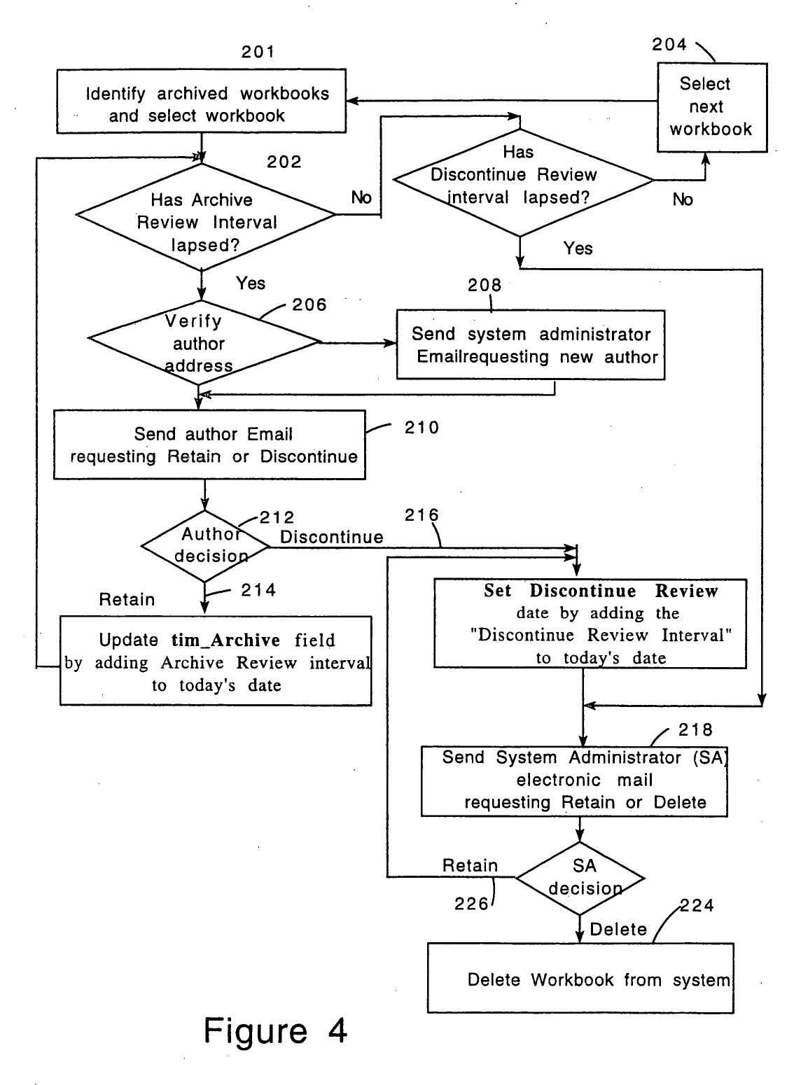

A document management procedure, called the Review/Retention Process, is carried out for all archived documents. This procedure is more fully illustrated in FIG. 4. Upon archiving of a workbook 138 within the repository 136 a review date is entered into a field entitled “tim_Archive” within the workbook 138. This is accomplished by adding the “Archive Review Interval” value to the current date and storing the sum in the tim_Archive field. At periodic intervals archived workbooks are identified by a software “agent” and a workbook is selected (block 201).

As seen in box 202, the software agent determines whether the required “Archive Review Interval” for the selected workbook, typically two years, has elapsed. This is determined by comparing today's date to the value in the tim_Archive field. If the Archive Review Interval has not elapsed the next workbook is selected (block 204). If the Archive Review Interval has elapsed then the system control module 152 verifies whether the author still has a mail address in the system address book 157 (block 206). If not, the system administrator (SA) is notified via electronic mail and a document link is included in the electronic mail to enable the system administrator to access the workbook and assign a new author (block 208). If the author does have a mail address in the system address book 157 then the author is notified by electronic mail that the workbook status is to be reviewed (block 210).

As designated by block 212, the author is required to make a decision, and is presented with two options, “Retain” or “Discontinue”. Only two decision buttons are provided to the author to select, since the author does not have authority to delete workbooks.

As designated by block 214, if the activity related to the document/workbook is still active the author selects the Retain button, the workbook is retained in the Archive and the tim_Archive field in the workbook is reset by adding the “Archive Review Interval” to the current date. Upon the occurrence of the new review date the author will again receive an electronic mail for the same decision. In the event the author no longer available in the system address book 157 the system administrator will be notified to assign a new author.

As designated by block 216, if the activity related to the workbook is no longer active, yet there is a need to keep the workbook in the archive, the author selects the Discontinue button. The two-year author review cycle is stopped and a “Discontinue Review” date is set by adding the “Discontinue Review Interval” (typically three years) to the date when the Discontinue decision was made in a separate field within the workbook.

As designated by block 218, when a workbook has been marked Discontinue Review, the system administrator will receive an electronic mail message with a document link designating the workbook to be deleted. The system administrator reviews the discontinued workbook marked Discontinue Review and has the authority to either delete the workbook (block 224) or to retain the workbook and review it again after the expiration of another. “Discontinue Review Interval” (block 226).

When an author needs to modify a document in an archived workbook, that user selects the archived workbook for IMPORT. A new workbook with a new system generated identification number is created and the contents of the archived workbook would then be imported, i.e., copied, into the newly created workbook. The original workbook is marked “Superceded by ####”, where #### is the identification number of the new workbook. The original workbook is then marked “discontinued” and an electronic mail sent to the system administrator to determine if it should be deleted. The system administrator may delete the old (superceded) workbook. Or, the system administrator may do nothing and the discontinued workbook will be reviewed again after the expiration of another “Discontinue Review Interval”. The new workbook is marked “Supercedes ###” where ### is the number of the old workbook. All of the text/data of the superceded workbook is imported into the new workbook, except the approvals. New documents and documents in a new workbook would have to be completed and signed by the author and submitted for approval by the audit agency.

We claim:

1. A safety management process for managing the use of a biological agent comprising the steps of:
a) preparing a listing of parameters regarding a proposed use of a biological agent, the listing including:
the identity of a biological agent proposed to be used by a user;
the use to which the biological agent is proposed to be put;
the medium in which the proposed use will occur; and
the containment system in which the proposed use will be practiced;
b) based upon the received parameters using a decision engine to determine a hazardous risk classification of the biological agent;
c) generating a bio-safety level designation of the use, the bio-safety level designation being based upon the hazardous risk classification;
d) reviewing a proposed set of operating procedures and conditions governing the proposed use, the degree of specificity of the information in the proposed set of operating procedures and conditions being dependent upon the bio-safety level designation,
e) generating comments regarding the proposed set of operating procedures and conditions, the comments optionally including modifications to the proposed set of operating procedures and conditions;
f) repeating steps d) and e) until an approval by an audit agency is generated, the approval containing a final set of operating procedures and conditions; and thereafter,
g) practicing the use in accordance with final set of operating procedures and conditions.

2. The process of claim 1, wherein the parameters of step a) further including one or more of:
a recommended hazardous risk classification;
the type of user;
the level of training of the user;
regulations to be followed for the biological agent; and
the level of medical assessment and observation required for the user of the biological agent.

3. The process of claim 1 further comprising the step of storing the final set of operating procedures and conditions in an archive.

4. The process of claim 1 wherein the decision engine comprises the steps of:
h) determining whether the biological agent presents a risk of a biological effect to a human;
i) if a risk to a human, identifying the mode of entry of the agent;
j) identifying the severity of the biological effect to a human upon exposure;
k) based upon the results of steps (i) and (j) assigning a hazardous risk classification to the biological agent.

5. The process of claim 1 wherein the decision engine of step b) comprises the steps of:
i) determining whether the biological agent is an environmental hazard;
ii) determining whether the biological agent is an animal hazard;
iii) determining whether the biological agent is a human hazard, and if a human hazard
A) identifying whether the mode of entry of the biological agent is through the skin;
B) identifying whether the mode of entry of the biological agent is through the mucus membranes;
C) identifying whether the mode of entry of the biological agent is through the eyes;
D) identifying whether the mode of entry of the biological agent is through inhalation;
E) identifying whether the mode of entry of the biological agent is through ingestion;
iv) identifying the severity of the biological effect to a human upon exposure;
v) based upon the results of steps (i) through (iv) assigning a hazardous risk classification to the biological agent.

6. The process of claim 5 wherein step iii)A) identifies whether the mode of skin entry is percutaneous.

7. The process of claim 1 wherein the procedures and conditions of step d) are prompted by providing the user with a list of informational requirements, the specificity of informational requirements being selected in accordance with the bio-safety level designation, comprising:
description of the equipment to be used to carry out a proposed procedure; and
description of the steps of the procedure to be performed.

8. The process of claim 1 wherein, prior to any change in the biological agent, the approval of operating procedures and conditions by the audit agency of step f) is automatically revoked and steps a) through g) are repeated.

9. The process of claim 1 wherein prior to any change in operating procedures and conditions, thereafter steps e) through g) are repeated.

10. The process of claim 1 wherein a history of the biological agent parameters, hazardous risk classification, audit agency comments and approvals, operating procedures and conditions and audit agency comments and approvals thereof is maintained in an archive.

11. An safety management process for managing the use of a biological agent comprising the steps of:
a) receiving from a proposed user a listing of parameters regarding a proposed use of a biological agent, the listing including:
the identity of a biological agent proposed to be used by the user;
the use to which the biological agent is proposed to be put;
the medium in which the proposed use will occur; and
the containment system in which the proposed use will be practiced;
b) based upon the received parameters, using a decision engine to determine a hazardous risk classification of the biological agent;
c) based upon the hazardous risk classification determining a bio-safety level designation for the proposed use and returning the bio-safety level designation to the proposed user;
d) receiving from the proposed user a proposed set of operating procedures and conditions governing the proposed use, the degree of specificity of the information in the proposed set of operating procedures and conditions being dependent upon the bio-safety level designation;
e) providing to the proposed user comments regarding the proposed set of operating procedures and conditions, the comments optionally including modifications to the proposed set of operating procedures and conditions;
f) repeating steps d) and e) as needed until an approval containing a final set of operating procedures and conditions is granted; and thereafter
g) providing the final set of operating procedures and conditions to the proposed user.

12. The process of claim 11 further comprising the step of storing the final set of operating procedures and conditions in an archive.

13. The process of claim 11 wherein, prior to any change in the biological agent, steps a) through g) are repeated.

14. The process of claim 11 wherein prior to any change in operating procedures and conditions, thereafter steps e) through g) are repeated.

15. The process of claim 11 wherein the decision engine comprises the steps of:
h) determining whether the biological agent presents a risk of a biological effect to a human;
i) if a risk to a human, identifying the mode of entry of the agent;
j) identifying the severity of the biological effect to a human upon exposure;
k) based upon the results of steps (i) and (j) assigning a hazardous risk classification to the biological agent.

16. An safety management process for managing the use of a biological agent comprising the steps of:
a) preparing a listing of parameters regarding a proposed use of a biological agent, the listing including:
the identity of a biological agent proposed to be used by a user;
the use to which the biological agent is proposed to be put;
the medium in which the proposed use will occur; and
the containment system in which the proposed use will be practiced;
b) based upon the parameters using a decision engine to determine a hazardous risk classification of the biological agent;
c) receiving from a safety audit agency a bio-safety level designation governing the use, the bio-safety level designation being based upon the hazardous risk classification;
d) submitting for review by the safety audit agency a proposed set of operating procedures and conditions governing the proposed use, the degree of specificity of the information in the proposed set of operating procedures and conditions being dependent upon the bio-safety level designation:
e) receiving from the audit agency comments regarding the proposed set of operating procedures and conditions, the comments optionally including modifications to the proposed set of operating procedures and conditions;
f) repeating steps d) and e) until an approval by the audit agency is received, the approval containing a final set of operating procedures and conditions; and thereafter,
g) practicing the use in accordance with final set of operating procedures and conditions.

17. The process of claim 16 further comprising the step of storing the final set of operating procedures and conditions in an archive.

18. The process of claim 16 wherein, prior to any change in the biological agent, steps a) through g) are repeated.

19. The process of claim 16 wherein prior to any change in operating procedures and conditions, thereafter steps e) through g) are repeated.

20. The process of claim 16 wherein the decision engine comprises the steps of:
h) determining whether the biological—agent presents a risk of a biological effect to a human;
i) if a risk to a human, identifying the mode of entry of the agent;
j) identifying the severity of the biological effect to a human upon exposure;
k) based upon the results of steps (i) and (j) assigning a hazardous risk classification to the biological agent.

21. A system for managing a safety process comprising:
a) a server node having a processor and a memory therein, the memory having a user-accessible section and a repository section,
the processor having a decision engine implemented therein for determining a hazardous risk classification of a proposed use of a biological agent;
the user-accessible section having at least workbook, comprising at least one document, affiliated with a user and containing parameters and information items created by that user acting as an author;
the decision engine having access to the parameters and information items in the at least one document;
the repository section having at least one library having at least one workbook therein, the workbook being affiliated with a user and containing documents that have been signed by that user acting as an author and that have been signed by a audit agency;
b) at least one user node connectable to the memory of the server, the user node being operable in either an author mode or a reviewer/approver mode or a read-only access mode,
when operable in the author mode,
the user node being connectable to a workbook of a user for retrieval of a document for editing or subsequent signing by that user acting as an author, and
the user node being connectable to a workbook in the workspace assigned to that user, for storage of a document or a signed document in the workbook of that user acting as an author,
wherein the author-signed document includes a signature string representative of the identity of that user acting as an author and a first date/time stamp provided by the server;
when operable in the reviewer/approver mode,
the user node being connectable to the workbook for retrieval of an author-signed document in the workbook for review by a user acting as a safety audit agency, and,
after review and approval of the signed document, for storage of an approver-signed document in a workbook in the repository section of the memory;
wherein the author-signed and approved document includes at least one approver signature string representative of the identity of a user acting as an approver and a second date/time stamp provided by the server node.

22. The system of claim 21 further comprising a control module which permits an author to withdraw a signed document for further revision, the control module removing the author signature and any audit agency approval signatures from the document to create an unsigned document for further editing and subsequent resigning by that author.

23. The system of claim 21 the server node of the system further comprising:
a custodian module maintaining access control lists for allowing:
write access by a first user acting as an author to documents stored in the personal workspace of that user;
write access by a second user acting as an additional author to documents stored in the personal workspace of the first user, the second user having been granted such access by the first user;
read-only access by a third user to documents stored in the workspace of the first user, the third user having been granted such access by the first user; and
read access by a user acting as a audit agency to a document stored in the personal workspace of the first user.

24. The system of claim 23 wherein the custodian module maintains an access control list for allowing read access by a user to approved documents stored in the repository section.

25. The system of claim 21 wherein the server node further comprises:
i) in the user-accessible section, a database comprising:
a) a list of biological agents and associated hazard parameters;
b) document links to web-based regulations and safety, health and environmental standards;
c) a library of forms for prompting the author for informational items;
d) edit histories of document entries;
ii) in the repository section, a document management database comprising:
a) a library of author-signed and audit agency-approved documents;
b) a scheduler which initiates automatic review of documents by the author at predetermined time intervals.
